(19) United States
(12) Patent Application Publication
(10) Pub. No.: US 2008/0162181 A1
(43) Pub. Date: Jul. 3, 2008

(54) Method and Apparatus For Health Control

(76) Inventors: Shlomo Ben-Haim, London (GB); Benny Rousso, Rishon-LeZion (IL)

Correspondence Address: Martin Moynihan;PRTSI, Inc., P.O. Box 16446, Arlington, VA, 22215, US

(21) Appl. No.: 11/569,995

(22) PCT Filed: Jun. 2, 2005
(86) PCT No.: PCT/IL05/00585

§ 371 Date: Sep. 25, 2007

Related U.S. Application Data
(60) Provisional application No. 60/575,802, filed on Jun. 2, 2004.

(51) Int. Cl. G06Q 50/00

(52) U.S. Cl. 705/2

(57) ABSTRACT

A method of health care financing, comprising: calculating an economic burden on an entity caused by a health situation; providing, by a third party, application and monitoring of a health plan for at least 10,000 individuals in least part of the entity; and paying to the third party in response to a proof that said burden is reduced.

### RELATED APPLICATIONS

This application claims the benefit under 119(e) of U.S. provisional application 60/575,802, filed Jun. 2, 2004, the disclosure of which is incorporated herein by reference.

### FIELD OF THE INVENTION

The present invention relates to healthcare and wellness, for example for alleviating obesity.

### BACKGROUND OF THE INVENTION

There is a worldwide epidemic of metabolic diseases (diabetes type 2, hypertension, CVD etc.) that result from obesity. There has been an alarming increase in the global prevalence of obesity and overweight individuals, and most countries are not equipped or capable of dealing with the consequent health expenditures. Other diet and life style-related diseases are also well known. It should be noted that many countries, while possibly aware that a total savings in cost and increased GDP might arise from suitable healthcare, do not or cannot make the necessary changes.

### SUMMARY OF THE INVENTION

An aspect of some embodiments of the invention relates to controlling the wellness of a large population, in which standards for care are set and products provided by manufacturers are ranked according to the standards and according to feedback from users of the products. In an exemplary embodiment of the invention, a framework is provided for conducting large scale studies and analyses of data according to various population breakdowns. In an exemplary embodiment of the invention, the feedback is provided continuously and on a wide base of data collection, as opposed to controlled small studies. Optionally, the feedback comprises feedback on the use of a wide range of daily use products, including for example, at least 20%, 40%, 60% or more of a daily consumption, by volume, of products. In an exemplary embodiment of the invention, the feedback-is product/manufacturer specific.

In an exemplary embodiment of the invention, a multi-part entity is provided including a for profit portion that generates product certifications and/or manufactures products and a non-profit portion which generates guidelines and/or tests the validity of certifications. Optionally, the entity as a whole negotiates with large organizations, such as governments, to implement its goal of improving healthcare. In an exemplary embodiment of the invention, the entity offers a deal to the government, wherein payment is made based on results in improving health, optionally, as a percentage of the change or other function of the economic gain of the government or organization.

In an exemplary embodiment of the invention, a framework is provided to allow a government or other large body to receive valid and/or up-to-date information regarding the wellness of its population and/or effect of various campaigns and/or healthcare initiatives.

In some embodiments of the invention, the goals of the embodiments are realized by the combination of products whose content is analyzed, a large user base of the products and wide reporting of the effects of the products on the user base. The use of the products and the collection of data outside of a controlled study environment allows for a very large increase in the user base. Optionally, the reduced rigorousness of the results is offset by the larger population and/or continuous reporting of effects. Optionally, the use of large populations enables various effects to be detected in a shorter time.

An aspect of some embodiments of the invention relates to a method of treating large populations, in which financing for the treatment is provided by a third part which is repaid based on shown results. In an exemplary embodiment of the invention, the repayment is by a fourth party, for example one not associated with the target population, such as a world monetary organization. In an exemplary embodiment of the invention, little or no direct expenditures are required of the population and/or a government body thereof, for example, expenditures less than 30%, 20%, 10%, 5% or less of the cost of treatment for diseases being prevented. Optionally, existing medical treatment expenditure continues but its composition is changed and its sum optionally reduced. This expenditure is not included in the direct expenditures described above.

An aspect of some embodiments of the invention relates to making health decisions based on a large amount of information, optionally with the information being updated often, such as more often than once a month or once a week, over a significant period of time. Optionally, the decisions are small decisions, for example ones that have a small effect (even if cumulatively a large effect is achieved), for example, decisions on a daily or weekly basis. In an exemplary embodiment of the invention, the decisions include daily or weekly changes in lifestyle and/or in product consumption. In an exemplary embodiment of the invention, the information is continuously updated from the effects of similar decisions on large populations. Optionally, the information is broken down demographically to match a particular user's demographics.

In an exemplary embodiment of the invention, the information is provided to healthcare providers, for example for deciding on which more detailed or controlled experiments to run and/or on health and/or safety ranking for various products.

In an exemplary embodiment of the invention, there is provided a home care device that both acquires physiological and/or lifestyle information about a user and dispenses personalized advice to the user, based on information collected from similar users.

An aspect of some embodiments of the invention relates to costing of products and/or services and/or tariffs and/or subsidies to such products and/or services, which costing takes into account the value to a user of the product/service. In an exemplary embodiment of the invention, feedback from the users is used to assess the impact of a product and thus a reasonable cost structure and/or incentive therefore.

There is thus provided in accordance with an exemplary embodiment of the invention a method of health care financing, comprising:

calculating an economic burden on an entity caused by a health situation;

providing, by a third party, application and monitoring of a health plan for at least 10,000 individuals in at least part of the entity; and

paying to the third party in response to a proof that said burden is reduced.

Optionally, said payment is by a loaning entity which lends money to said entity.

In an exemplary embodiment of the invention, said entity is a country.

In an exemplary embodiment of the invention, said entity does not pay for said provision more than 20% of a cost of said provision.

In an exemplary embodiment of the invention, the method comprises calculating a cost-effectiveness of a product.

In an exemplary embodiment of the invention, providing comprises ranking products according to their health effects.

In an exemplary embodiment of the invention, calculating comprises calculating according to a set of guidelines defined by a non-for-profit entity.

In an exemplary embodiment of the invention, the method comprises providing a certification to one or more products and collecting a certification fee from a manufacturer of such products.

In an exemplary embodiment of the invention, the method comprises negotiating with said entity to reduce market barriers to said certified products.

There is also provided in accordance with an exemplary embodiment of the invention, apparatus for health care, comprising:

(a) at least one database storing product information related to health;

(b) a plurality of reading stations adapted to identify a product and provide product usage information in response thereto;

(c) a plurality of health monitoring stations adapted to acquire health information about individuals; and

(d) at least one analysis station adapted to correlate health information provided by said health monitoring stations with product usage information provided by said reading stations and determine therefrom an effect of said product on health.

Optionally, at least 10% of said health monitoring stations are located in persons' homes.

Optionally, at least 10% of said health monitoring stations are located in stores or healthcare locations.

Optionally, at least 10% of said reading stations are located in persons' homes.

Optionally, at least 30% of said reading stations are located in stores.

Optionally, at least 20% of said reading stations are adapted to record an identification of a person providing a product.

Optionally, the apparatus comprises a database of health information of said individuals.

Optionally, said analysis station is adapted to detect demographic specific effects for a demographic group smaller than 1% of said individuals.

Optionally, said analysis station is adapted to update said analysis at least once a week taking into account at least one factor that changes for an individual faster than once a week.

Optionally, said analysis station is adapted to take into account location specific effects relating to fewer than 1% of the individuals.

In an exemplary embodiment of the invention, said individuals comprise at least 50,000 individuals.

In an exemplary embodiment of the invention, at least one of said reading stations and said health monitoring stations are adapted to assist compliance by a user.

In an exemplary embodiment of the invention, at least one of said reading stations and said health monitoring stations are adapted to give individualized medical advice.

In an exemplary embodiment of the invention, said analysis station is adapted to determine the effect of a health promotion.

In an exemplary embodiment of the invention, said analysis station is adapted to determine a change in economic health burden of an entity comprising said individuals.

In an exemplary embodiment of the invention, said analysis station is adapted to suggest costing for products according to their determined health effects.

There is also provided in accordance with an exemplary embodiment of the invention, a method of health advice to a user characterized by demographic and personal criteria, comprising:

(a) receiving at least 10 queries a month from said user

(b) extracting a suitable medical advice for said user in response to at least one of said queries, based on said user's demographic information and personal information; and

(c) reporting said advice to said user.

There is also provided in accordance with an exemplary embodiment of the invention, apparatus for product costing, comprising:

(a) an input for basic product cost;

(b) an input for product economic health benefit; and

(c) circuitry for calculating a cost based on said basic price and based on said benefit.

### BRIEF DESCRIPTION OF THE FIGURE

FIG. 1 is a schematic block diagram of a configuration for healthcare, in accordance with an exemplary embodiment of the invention.

### DETAILED DESCRIPTION OF EXEMPLARY EMBODIMENTS

### Overview

In an exemplary embodiment of the invention, a large scale health control and/or support system is provided. The effects of various products (also promotions, services) on users are monitored and then fed back to an entity, which entity can have an effect on the composition and/or promotion of the products.

### Exemplary System Configuration

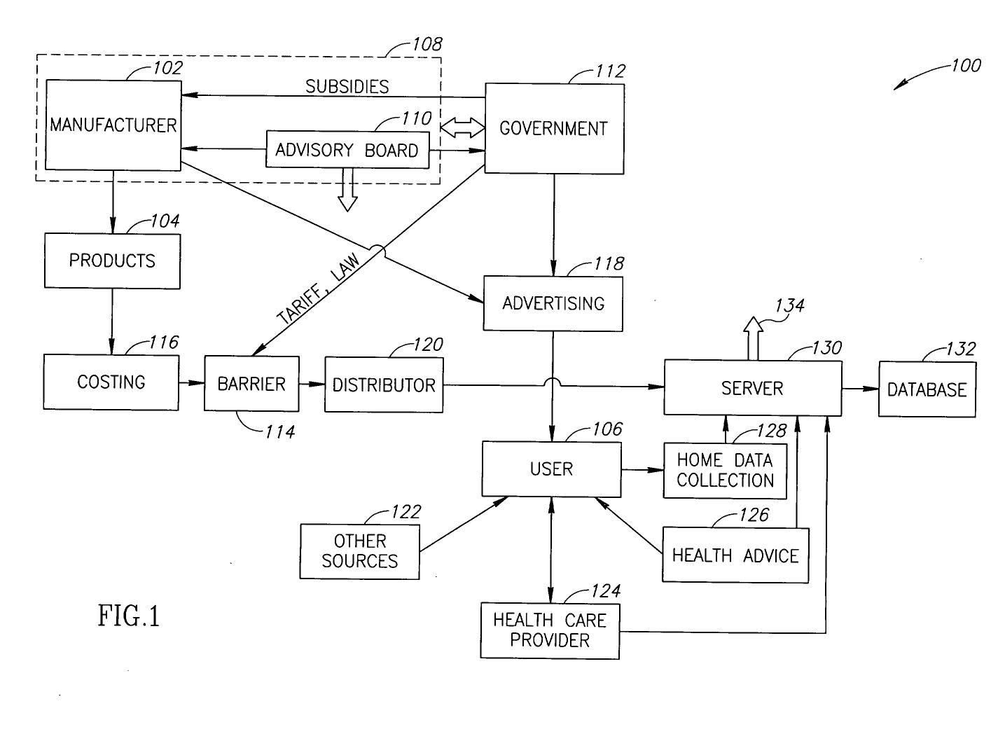

FIG. 1 is a schematic block diagram of a configuration 100 for healthcare, in accordance with an exemplary embodiment of the invention. It should be appreciated that not all the elements shown are essential. Rather, the elements are shown so that their possible integration into a scheme according to an embodiment of the invention, is clear.

One or more manufacturers 102 manufactures one or more products 104. For brevity, the description will focus on food products and/or treatments for obesity, however, the products may be of a different type. A plurality of users 106 use the product and it has an effect on their health, which effect can be reported back, for example as described below. In an exemplary embodiment of the invention, manufacturer 102 is part of a health entity 108 that attempts to improve the health of the user. Optionally, entity 108 comprises a non-for profit scientific advisory board 110. Optionally, advisory board 110 determines long and/or short term health goals and/or determines the health effects of product 104.

In an exemplary embodiment of the invention, entity 108 negotiates with one or more governments, insurance companies and/or large employers 112. Such negotiation may be, for example, to help reduce tariffs or change laws that act as barriers 114 to importation of products 104. Alternatively or additionally, government 112 may provide a subsidy or tax reduction.

In an exemplary embodiment of the invention, a non-profit entity, such as board 110, also defines guidelines for product certification. Optionally, a separate, optionally, for-profit entity (also possibly part of entity 108) provides corporations, insurance companies and/or governments with the tools necessary to reduce obesity rates within their respective populations by recognizing and certifying products and services that have a positive impact on the short and long term effort to reduce obesity. In return for certification, product manufacturers optionally pay an annual fee derived from a percentage of annual product sales. One goal optionally is for target populations to have affordable access to healthier products and medical treatment options. The use of not for profit organizations may improve their reliability (real and/or perceived).

In an exemplary embodiment of the invention, for example, when applying a method of the invention to a target population, a consulting unit (possibly board 110) will perform in-depth demographic and nutritional studies of a target population, and will determine optimal food products and weight reduction solutions based on genetic, epidemiological and/or economic analysis. These optimal food products will be given a consortium brand of approval and/or ranking and will be promoted. Promoted products will be optionally subject to a certification or branding fee that will total a percentage of annual product sales. Also non-optimal products may be ranked. Optionally, a small number of ranks is provided. Optionally, for example as described below, the ranking is personalized to the user and/or for different disease states. Optionally, a product includes a code and a user can see the ranking of the product for him, by entering the code into a health advice unit 126 or a similar unit at a distributor 120. Optionally, a report by the consulting board is used to assist in negotiations with a representative of the target population.

Optionally, a costing 116 takes into account the health benefits to the user and then a manufacturer or other entity promotes the product as such (e.g., having a health economic value which offsets an increased product cost, for example). Optionally, costing includes determining suitable tariffs and/or subsidies for products, for example, from a manufacturer and/or from a government point of view. Optionally, costing includes costing for changes in manufacturing processes, raw ingredients and/or ingredient sources, for example, to eliminate toxins or to replace materials with different mechanical properties (e.g., viscosity). Optionally, costing is used to calculate cost-effectiveness of campaigns, for example based on expected costs and realized benefits in other target populations. Optionally, manufacturing data and/or alternatives are used as input to the costing.

In some embodiments of the invention, a tax is placed on products or product types shown to have a negative health consequence.

Users 106 are generally exposed to promotions via advertising 118, for example, media advertising and on-product advertising. Advertising may be initiated, for example, by government 112 (e.g., to promote a healthy lifestyle) and by manufacturers 102 or by one or more distributors 120 (e.g., in an effort to promote sales, not shown).

Mass advertising and educational campaigns aimed at local consumers (with recognizable celebrities and opinion leaders) are optionally used to increase brand product awareness. Financial incentives in the form of sales and free samples optionally encourage product purchases and consumption on an individual level. A prevention unit (e.g., part of entity 108 or a separately certified entity) will optionally install monitoring systems in local food stores and/or homes to record consumer buying trends. The data is optionally analyzed to reflect the relative success of an initiative.

It should be appreciated that other products, possibly similar to product 104 may be provided from other sources 122. While not analyzed, users can report on their usage. Depending on the similarity to certified products, a meaningful health care control may be provided, once a minimum of products are certified and/or controlled. In some embodiments of the invention, when viewing statistical information about demographics, the effect of the other products may be ignored. For example, if a certain food improved a group of persons, then the effect is true if many people in the group all do a non-reported activity. For a particular person carrying out a non-reporting activity, such an approximation may fail. Optionally, however, typical habits of exemplary persons are collected, for example using an in-depth interview. Optionally, a user is allowed to select which of a plurality of stored profiles he is like (e.g., eats peanuts at the ballpark and pop-corn at the movies 3 times a month). Alternatively or additionally, a person is matched to one of the exemplary users based, for example, on a matching of demographic data and/or consumerism habits. Some such methods of matching are known in the art of customer profiling for advertising and may be used here as well.

In general, health care for user 106 is provided by a health care practitioner or clinic 124. In an exemplary embodiment of the invention, personalized health advice is provided by an advice device 126, which is optionally integrated into a home data collection unit 128, for example as described below.

In an exemplary embodiment of the invention, user health data and/or consumption and/or purchasing data are collected, for example by distributor 120 (e.g., at supermarket checkout), healthcare provider 124 (e.g., at a clinic) and/or home collection device 128. In an exemplary embodiment of the invention, a user is offered a discount if the user uses an ID card, store card, membership card or credit card or other identification means. Optionally, this data is fed to a server 130 and/or a database 132. The server/database configuration can be, for example, centralized, distributed and/or hierarchical. Analyses run on the collected data are optionally used for one or more of providing advice to user 106, suggesting effectiveness of a treatment/product/promotion to entity 108 and/or providing government 112 with information about expected health costs. Other possible analyses and/or uses are described below. An arrow 134 from server 130 indicates that data and/or analysis of data flows from server 130 and/or database 132 to many elements of configuration 100.

It is a particular feature of some embodiments of the invention that due to the large population base, personalized advice can be provided for persons belonging to a relatively narrow demographic group.

In an exemplary embodiment of the invention, the methods are applied to large numbers, for example, over 10, 50, 100, 200, 2000 or more products, over 2, 10, 20, 40, 200 or more manufacturers, over 100, 1000, 10,000, 100,000, 1,000,000, 10,000,000, 100,000,000 or more people, over 10, 50, 100, 300, 2,000, 10,000, 100,000 or more super-markets, food providers or health care locations. Optionally, the users can be located in multiple locations, such as spread over more than 100, 1000, 10,000 or more square kilometers (with over 1 person per each of the square kilometers). Optionally, the users are spread over multiple countries, for example, 1, 2, 4, 8, 10 or more countries. In some embodiments, values intermediate to the above values ranges are used.

In an exemplary embodiment of the invention, analyses are updated more often than once a week, more often than once a day, more often than once an hour, optionally being recalculated when requested. Optionally, at least 10, at least 100, at least 1000 analyses are updated at those rates. Optionally, at least 50% of widely used analyses are so updated, for example, at least 50% of analyses requested more often than once a week.

In an exemplary embodiment of the invention, the completeness of reporting of usage of products is less than 100%, less than 80%, less than 60%, or even smaller. Alternatively or additionally, accuracy of reporting is at similar lower than 100% values. This is in general contrast to studies where high reporting accuracy and completeness are generally required in order to obtain meaningful results. Optionally, at least some of users 106 and/or other entities in configuration 100 are provided with an incentive to increase the accuracy of reporting. In an exemplary embodiment of the invention, the incentive is provided so that a more exact study can be carried out, to calibrate for the effects of incomplete reporting or to perform within subject analysis and/or studies. While relative large number of users may be provided with an incentive, this may still be a very small percentage (e.g., <10%, <1%) of the population using configuration 100.

In an exemplary embodiment of the invention, personalized demographic health information (e.g., advice, reports) is provided based on a grouping comprising less than 5%, 2%, 1%, 0.5%, 0.1%, 0.05% or an intermediate or smaller percentage of the target population.

### Certification

In an exemplary embodiment of the invention, a certification process comprises one or more of:

(a) analyzing the effect of a product (e.g., fibers, caloric content, saturated fat);

(b) analyzing an expected use of a product;

(c) determining a product's components (e.g., wheat, sugar, salt);

(d) analyzing the individual health effects of components of the product;

(e) analyzing the interaction between product components;

(f) analyzing the interaction between product components and other products that may be consumed at a same time;

(g) generating a ranking depending on the health effect of the product, optionally taking into account the target demographics and/or particular disease situations.

(h) repeating certification if an unexpected effect is noted on the population;

(i) periodically repeating the certification process.

(j) perform studies (optionally with some level of control) on the population to assess the meaning of a health effect and/or to obtain data missing for the analysis.

(k) analysis and/or generation of literature on the product and/or its components.

### Financing and Economic Analysis

Addressing the obesity pandemic during its incipient stages can save a significant amount of money for countries that are already spending billions of dollars on healthcare expenditures from diet-related diseases. In an exemplary embodiment of the invention, predictive econometric models are used to determine the prevalence of obesity in a specific population and the consequent healthcare costs. Alternatively or additionally, these models can optionally quantify the potential savings in national funds that will result from implementation of one or more program plans for obesity reduction. In an exemplary embodiment of the invention, the models use linear prediction. In another exemplary embodiment, one or more country templates are created from known progression and disease rates and the present and future disease rates in a new country are estimated by matching the new country to a template. Optionally, one or more demographic parameters are used for the matching, for example, race, gender, ages, current weight distribution and current typical diets.

In an exemplary embodiment of the invention, an entity will solicit funds from organizations such as the World Bank and the IMF to finance its initiatives in each specific country. These organizations all have an incentive to support obesity reduction as a way of securing their existing loans. For example, the World Bank has given India approximately $59 billion in loans. As of June 2003, the country's active credits to the World Bank totaled over $13 billion ($2.45 billion concern health, nutrition and population projects). India is simultaneously spending over $3.4 billion annually in overall diet-related healthcare costs (this figure reflects 1995 expenditure, and the amount spent today has only increased). The country is estimated to have the largest diabetic population in the world (over 45 million individuals), and its increasing healthcare costs threaten to bankrupt the government, rendering it incapable of repaying outstanding World Bank loans. Consequently, the World Bank has obvious interests in supporting nation wide obesity reduction initiatives that will reduce healthcare expenditures of obesity and its co-morbidities. The payment to the entity can be, for example, as a loan insurance sum directly from the loaner (IMF or World Bank) or by the target country, for example, on provision of proof and/or as a percentage of, reduction in diet-related health care costs. On-going and/or periodic reporting of the effect of the method and its economic consequences are an important feature of some embodiments of the invention. Optionally, a more generalized payment scheme is provided, for example, providing a monopoly, fixed rates, reduced tariffs or other benefits to manufacturer 102. Alternatively or additionally, the payment is as a function of economic improvement and/or in response to questionnaire filling out by the users.

In an exemplary embodiment of the invention, entity 108 will approach a country after having analyzed its economic health burden and offer to take responsibility for the burden and be reimbursed upon success.

In an exemplary embodiment of the invention, the entity will use its economic advantages as a leverage to expedite national regulatory approval for its certified medical devices and weight reducing drugs. Branding can also prove advantageous when member companies of the entity apply for government reimbursement, since their product's long-term added value will already be quantified by the consulting unit's analysis. The treatment unit optionally monitors the effects of these various solutions on the obese population, for example, by installing monitoring devices in doctor's offices and clinics. In an exemplary embodiment of the invention, these devices will record one or more of population BMI, fat ratio, cardiac disease (e.g., entered manually or using EMG or stress test measurements), blood glucose levels and blood pressure readings, and monitor the changes over time. Optionally, the information is entered manually, for example by a physician or nurse. Additionally, the prevalence of co-morbidities is optionally monitored. The results can be transmitted in real time to a central database for further analysis, and correlation studies of brand food sales and clinical changes can be performed on the data provided. The financing organizations can be updated periodically.

In an exemplary embodiment of the invention, the country is encouraged to apply differential taxing depending on a food's rating. Optionally, these incentives are provided to participants in the plan, rather than being imposed directly on importers.

In an exemplary embodiment of the invention, the economic analysis includes an analysis of both direct and indirect costs of a disease state. While some of these costs may be estimated in studies, in an exemplary embodiment of the invention, the costs are updated using the methods of the present invention (e.g., sick days related to obesity in a particular target population can be measured more accurately than studies which discuss large inhomogeneous populations). In an exemplary embodiment of the invention, even more accurate costs are estimated, by taking into account the patient's fiscal state, for example their salary. The quality of estimation of future costs is optionally enhanced by incorporating information about the actual response to various initiatives and/or life style changes. Optionally, the costs related to obesity or another disease are estimated by assuming the costs of obesity to be a certain percentage of overall costs, for example, as shown by another study (or more in depth data collection for other users). In general, the availability of users that can be queried in greater depth may be used to provide more accurate estimates for various statistics of larger groups.

### Data Collection

In an exemplary embodiment of the invention, a health indicating system (e.g., a system that reports to a user his health state and/or collects health related information) is provided at multiple locations, for example, at super-markets and/or at people's homes. Optionally, a server-client configuration is used, for example, using cellular telephones or computers with cameras or bar-code readers, to identify products that are used by a user. The clients may be, for example, relatively thin clients with reduced hardware and/or software or may include at least part of a database of product information, for example, locally used information. Information regarding a product made available to a consumer can include, for example a rating (if none is shown on a product) caloric information and information on recommended serving methods (e.g., from a health point of view). Optionally, such computers or cellular telephones or other reading devices are provided as part of a health plan, for example, for no additional charge, or as part of an incentive program. Optionally, a user can indicate an expected way of use of the product. Optionally, the product information is provided as part of a check-out receipt, also including an indication of its suitability for the family/person using the product(s). Optionally, when providing information, the situation of an individual is taken into account, for example, glycemic index is shown for diabetic patients. In another example, food that is good for one patient (e.g., a diabetic) is not good for another (a celiac sufferer). In another example, a known recommended diet of an individual is used when providing recommendations (such as serving size). In another example, a recommended change in life-style is provided, for example, if a user pays for or is registered for such information. In another example, the product information depends on the size of the family that will use the product. In another example, medical recommendations, for example provided by a physician or generated on a WWW page (or IVR menu) via an interactive session between a computer or dietitian and the user. The information is optionally read-out as speech or printed out on a slip of paper or loaded into a personal memory storage device or smart card.

In an exemplary embodiment of the invention, the certification mark includes an RFID or similar device so that it can be tracked and/or information stored thereof. Optionally, RFID readers are also provided at home to facilitate automatic collection of such information as shelf life, meal use and garbage disposal behavior. For snacks, a reading is optionally made by moving the container of a product near an RFID reader. Optionally, an RFID is also provided for users, so that the linkage between user and product can be made more accurately. Optionally, a scale is provided to users and including an RFI reader, such that the scale can determine the current weight of a product—indicating an amount consumed. Imaging or other biometrics methods, such as fingerprint detection, may be used to identify the user.

In an exemplary embodiment of the invention, the information regarding what products are purchased and/or used is fed back to a central server. This information may be checked, for example, to prevent fraud (e.g., most individuals do not eat 20 Kg of rice a week). A voucher or cost reduction (e.g., at a check-out counter) are optionally generated, for example, based on compliance with a diet and/or compliance with the reporting requirements. Optionally, each product includes a unique bar code or other marking, to prevent re-entry of a same product twice.

In an exemplary embodiment of the invention, configuration 100 addresses privacy concerns. For example, while the information may be available per user of the system, the identity of the user may be hidden, for example by encryption or by a one-way mapping function such as hashing. Thus users need not fear that they are being tracked by the government or might lose benefits for not following orders. In some embodiments, some personal data is hidden and some is not, for example to allow insurance rates to depend on compliance, but not on race or genetic information. In an exemplary embodiment of the invention, a user can obtain personal information by entering a secret code and information that matches a hash of that code.

Optionally, a user can decide what of his information is made publicly available. Optionally, the more forthcoming the user is (e.g., providing in-depth interviews, reliable information), the lower the cost or possibly higher the incentives provided to such a user. A more private user, in contrast, may choose to hide all but weekly habits and demographic information. Optionally, the data collected about a user is filtered out to maintain privacy before being forwarded to the server.

In an exemplary embodiment of the invention, even though the government (or other entities) cannot directly query about a user, the data can still be available according to any non-identifying information, such as income, demographics, product consumption, etc. Further, aggregate data is available. Thus the ability of the government to obtain reliable predictions and analyses is not impaired. Various security schemes are known in the art and may be used, in particular schemes which prevent personal information from being extracted by performing narrow queries on a database. In the particular case of citizens and governments (or sales persons) it may be sufficient to prevent the large entity from obtaining a large number of identifications, while still allowing a small number of identifications to be collected.

### Data Extraction and Analysis

In an exemplary embodiment of the invention, tracking of health is provided. For example, a user may be encouraged to be weighed and/or have other physiological parameters measured. Optionally, such parameters are measured at a clinic, for example a local health clinic, at a drug store or at a supermarket. Optionally, also non-dieting (including, for example, both healthy and non-healthy individuals) people are encouraged to be measured, for example to provide a base-line against which proof of effectiveness can be shown. Optionally, a data collection device is provided in which when people pass an ID card, their physiological data (e.g., weight) is collected and reported to them. Optionally, some additional information may need to be provided by the people, for example, age. This information is optionally read off a medical card carried by such people at clinics. Optionally, health care information, such as reason for meeting the doctor and/or frequency thereof is used to assess the effects of life-style changes and/or the plan on a user.

In an exemplary embodiment of the invention, one or more of changes in morbidity rates, disease rates, weight, blood fat levels, blood glucose levels and/or other physiological parameters may be calculated in real time as compared to an expected or known untreated state. This information may be used, for example, to calculate financial savings (and thus possibly payment to the entity) and/or to fine-tune the plans being used, for example, diets (based on the effect of product mixes on health) or incentives. In an exemplary embodiment of the invention, one analysis performed is the determination of the effect of mixing different products and/or services. Optionally, such relatively fast feedback (e.g., minutes, hours, days, weeks or months, rather than years), is used to support testing various plans on small populations, so that a best plan for a community and/or demographics group may be determined.

In an exemplary embodiment of the invention, one or more of the following entities may obtain reports, for example the reports described herein: (a) A physician can see compliance information in a patient (or patients in general) and/or compare compliance and health effect in multiple patients and/or people. (b) A user may see his behavior and state and/or expected future trends, as compared to other people in a same or other country. (c) A manufacturer or distributor can see statistics of use and/or ratings of one or more products and/or in comparison between products. Optionally, a pricing advising program is provided, to suggest changes in pricing strategies. (d) Government and financing parties can see reports, for example, on health trends, costs and/or efficiency. In some cases, some of the reports are provided as aggregate data or information is hidden, for example to protect trade secrets, marketing information and/or personal information. Other groups may also be allowed to receive various reports. It is noted that some of these reports may be considered to be mega studies conducted and/or tracked by configuration 100, in substantially real-time. In some cases a campaign-specific report is generated. For example, configuration 100 can be used in the manner of a people-meter, which estimates the effect of a campaign. Optionally, the people chosen to be metered are provided with an incentive to ensure reporting. In one example, a campaign to use low-fat yogurts is measured by counting changes in the relative amounts of different yogurts eaten by metered people. Optionally, a link to supermarket or distributor information may be used, optionally, also for non-branded products. The existence of such a link may be guaranteed by a government or by payments, coupled with a promise of confidentiality.

In an exemplary embodiment of the invention, analyses and recommendations in configuration 100 take into account localization concerns and/or changes over time.

As an example of changes over time, foods have varying compositions based on the season and shelf age. Other examples of things that change over time are local temperature and humidity levels and items reported by the user (such as exercise levels and location indoors/outdoors).

A particular example of a time varying concern is time of day. A person's metabolism and/or absorption facilities are different at different times of day and different meal sizes may be expected at different times of day.

Examples of localization concerns include the weather, ethnic habits (e.g., the Ramadan fast which affects metabolism), climate, typical ethnicity and genomic makeup.

In an exemplary embodiment of the invention, by analyzing these effects on user response to products, better predictions can be made and/or studies and/or guidelines designed.

In an exemplary embodiment of the invention, analysis includes comparing a particular person to trends within similar groups. In an exemplary embodiment of the invention, this allows a more sensitive understanding of trends, for example helping detect local minima/maxima, helping define more exact goals and trends (rather than 2 Kg/week). In an exemplary embodiment of the invention, by comparing a person to similar people, exceptional people can be detected and/or modes of non-compliance guessed. Optionally, by comparing a person to similar persons a more precise response to customized treatment can be predicted. More customized treatments are optionally devised by comparing the effect to similar people and optimizing various parameters of the treatment (e.g., using search methods as known in the art).

In an exemplary embodiment of the invention, use is made of the fact when a group is made more homogenous, variability tends to go down and detection of exception is easier. Examples of more homogenous groups are groups based on age, BMI and degree and/or duration of diabetes. Optionally, a hierarchical and/or overlapping set of groups is generated, for example: {BMI>30}, {BMI>30 AND diabetes over 2 years}, {all of the above AND age >40}. Optionally, the groups where detect ability is best are presented to the user. This may be a group other than the narrowest one and is generally not the largest group either.

### Ranking, Presentation to Users and Compliance

In an exemplary embodiment of the invention, the following structure is used. One or more central servers store information about various food or other life-style products (such as exercise devices, medication and diet treatments). In an exemplary embodiment of the invention, a branding service is provided by which a food manufacturer brings his product to a location where various information about the device is collected, for example, its caloric value and its ingredients. Optionally, manufacturers are charged for such branding, for example, a fixed amount or a percentage, possibly on a non-linear scale as a function of sales. Optionally, the result of the branding is a certification mark which can be placed on the product. Optionally, the mark includes a rank, for example, a simple rank, such as one of a small number of symbols and/or colors which indicate a health-rating of the product. For example, 2, 3, 4, or 5 or more rating levels may be provided. Optionally, the ranking and/or testing of a product include a determining of the effect of usage of the product, for example, different caloric results are provided for different preparation methods (e.g., frying and steaming of rice). Optionally, ranking is performed for multiple disease situations as well, for example, for a different metabolic disease a different ranking may be relevant (e.g., obesity vs. diabetes). Multiple rankings may be presented on a single packaging, as described below, this information may be provided in a personalized manner. Optionally, a multi-information label is provided, which when viewed through a suitable and individualized optical filter, displays only the relevant ranking.

In an exemplary embodiment of the invention, health advice device 126 is used to provide additional information to a user. In one example, a user can input a proposed meal plan (or select among system proposed plans) and receive an expected benefit of the plan, optionally personalized to the user and/or his family.

In an exemplary embodiment of the invention, advice provided to users includes a prediction and an estimated progression of a health state and/or physiological measure (e.g., weight, CHF). In an exemplary embodiment of the invention, the advice includes an expected life expectancy and expected disability free life expectance. Optionally, a quality of life indicator is provided as well.

In an exemplary embodiment of the invention, advice includes advice on exercise. Optionally, device 126 shows the user what the expected benefit is from various types of exercise for him, under his present condition and/or food intake. In an exemplary embodiment of the invention, exercise effectiveness is also calculated based on one or more of intake, environment, personal characteristics, history and demographics. Previous effects of exercise are optionally factored in as well.

Optionally, device 126 is used to administrate a long term change in life style, for example, providing gradual changes in life style and/or providing incentives. Exemplary incentives are money, cost savings (e.g., coupons) and/or reduced insurance rates.

In an exemplary embodiment of the invention, a smart shopping card is provided at shopping locations. Optionally, the shopping cart recognizes the products placed therein (e.g., using RFID or barcode readers) and provides advice to the user. Optionally, the advice takes into account an identification of the user (e.g., via a biometrics sensor or an ID card reader), in preparing the advice. Optionally, the advice is generated using server 130 and/or database 132. Optionally, the shopping cart includes a speaker and/or visual display for providing numeric and/or non-numeric information, advice and/or targeted advertising. Optionally, the targeted advertising is geared to cause the user to change to a more healthy life style. Optionally, the advertising is not negative but more in the form of suggesting moderation and recommended lifestyle changes associated with the instant purchases and/or the user's history.

In an exemplary embodiment of the invention, a home health monitoring system is provided. Optionally, the system includes a reader to record the usage of products. Optionally, the system provides recommendations for recipes and/or can read barcodes or other signals off recipe books and provide advice on their suitability. Optionally, the system is also used to generate a shopping list recommended for a user. Optionally, portion sizes and/or food combinations are suggested, optionally based on known purchases. Optionally, the content of the purchases is encoded so that only the user with his personal (optionally one time) code can access the information. Alternatively, the purchasing information is sold to advertisers and/or other concerns and used to offset at least some of the cost of the system.

In an exemplary embodiment of the invention, configuration 100 provides tools to some or all of the entities shown in FIG. 1 to know what the more correct actions are. For example, information and tools to help decide what treatment (from manufacturer or healthcare system perspective) or action (from user's perspective) would better serve to increase health, reduce cost of health care, ensure compliance with treatment and/or instructions and/or return to a productive life faster. These tools may be used, for example, by insurance companies trying to decide what advice to give clients and/or what treatments to cover and for users trying to decide how to act (or what choices are bad and what are terrible).

In some embodiments of the invention, compliance is not guaranteed. For example, a person may buy medication and throw it in the garbage. Further, users may lie about their actions and/or food intake. In an exemplary embodiment of the invention, machines, such as glucometers, treadmills and other machines used by the user are connected to a data collection mechanism (e.g., the internet) and report compliance. Alternatively or additionally, incentives are provided to some or all of the population to comply or at least report compliance. Real compliance may be estimated from such incentive-related reporting and/or change in behavior.

In another embodiment of the invention, a user is fitted with a reporting device, such as a metabolic sensor, an eating detector and/or a movement tracker (e.g., GPS/INS). Thus compliance with eating instructions, exercise instructions and/or mobility ability can be detected. Further such sensors may also be used as physiological sensors to measure an effect of a treatment.

Alternatively or additionally, if a person repeatedly purchases a product, it is assumed it is being used. Optionally, the person is queried to see if it is actually being used. Alternatively or additionally, a compliance monitoring device is provided at the user's home, whereby an incentive is provided when a user is asked about compliance and reports positively.

### Variations and Non-obesity Uses

While the above description has focused on food, similar methods can be applied to medication and/or other medical treatments, such as exercise, whether for obesity of diet related problems or not. For example, when medicine is dispensed, a pharmacy can provide the information to server 130. Further, the act of prescription may also be tracked. Compliance with medicine taking can be reported by the user, for example in response to an incentive. Examples of variables of interest relating to taking of medication which may be tracked include, food interactions, medicine interaction, compliance with timing, compliance with term of use, compliance with dosage, stomach full/empty and/or other disease conditions. In an exemplary embodiment of the invention, one or both of effectiveness of medication and problems with compliance thereof and/or suitable usage instructions can be generated. This information may be used to certify a certain medication as being more reliable. Further, demographic effects may be of great interest for certain medication. Health measurements showing the continued effect of medication can help provide users with personalized information as to how they should be taking medication (or querying their physician about it). In an exemplary embodiment of the invention, medication is provided in a form which allows easy reporting of compliance. One example is that caplets or syringes include an RFID that is inserted into a compliance reading device at the patient's house, at the time of use. Another example is that the medication is provided in a smart package including a clock and a dispensing mechanism. Optionally, the home data collection device can serve as such a smart dispenser.

In an exemplary embodiment of the invention, other diet related diseases are tracked. Examples of such diseases include GI diseases, such as irritable GI syndrome, celiac disease and other GI sensitivities, food sensitivities, food allergies, gassiness, osteoporosis and anemia. Optionally, non-weight loss diets are tracked, such as special diets for lactation and/or body building. The measured parameters may be different for different diseases/conditions. A similar system may be used to track child care and prenatal care of a mother.

What is common to many of the above embodiments is that a tracking is made both of choices made by persons (e.g., in purchasing and/or compliance) and of the physiological effect on such persons. Such tracking and then analysis may also be used for non-diet issues, for example, smoking (e.g., type of smoking material and frequency and associated other activities), STDs (e.g., type of behavior, use of preventive techniques and/or medication and/or education), contagious diseases, and other conditions where changes in personal choice can affect (e.g., increase or decrease) health care costs.

In a non-country application, a similar process may be applied to a company. For example, a large company can pay a percentage of the resulting reduction in health care costs or worker sick day costs after it is proven that a health-related plan has such an effect. Optionally, the methods and/or apparatus used are designed to provide functionality to multiple players, for example, one or more of, manufacturers, distributors, users, physicians and governments.

It will be appreciated that the above described methods of health control may be varied in many ways, including, omitting or adding steps, changing the order of steps and the types of devices used. In addition, a multiplicity of various features, both of method and of devices have been described. In some embodiments mainly methods are described, however, also apparatus adapted for performing the methods are considered to be within the scope of the invention. It should be appreciated that different features may be combined in different ways. In particular, not all the features shown above in a particular embodiment are necessary in every similar embodiment of the invention. Further, combinations of the above features are also considered to be within the scope of some embodiments of the invention. Also within the scope of the invention are kits which include sets of a device for home use and/or a device for store use and/or software. Also, within the scope is hardware, firmware, software and computer readable-media including such software which is used for carrying out and/or guiding the steps described herein, such as data analysis and providing feedback. In particular it should be noted that the home and store devices may be implemented in many ways, including integration with existing electronic devices, such as PDAs, cellular telephones and personal computers. The servers and databases maybe implemented in many ways, such as known in the art, including distributed implementations and various backup and hierarchal schemes. The analysis may be performed remotely form the server and different analyses may be performed at a same or different locations. Section headings are provided for assistance in navigation and should not be considered as necessarily limiting the contents of the section. When used in the following claims, the terms “comprises”, “includes”, “have” and their conjugates mean “including but not limited to”. It should also be noted that the device is suitable for both males and female, with male pronouns being used for convenience.

It will be appreciated by a person skilled in the art that the present invention is not limited by what has thus far been described. Rather, the scope of the present invention is limited only by the following claims.

1. A method of health care financing, comprising:
calculating an economic burden on an entity caused by a health situation;
providing, by a third party, application and monitoring of a health plan for at least 10,000 individuals in at least part of the entity; and
paying to the third party in response to a proof that said burden is reduced.

2. A method according to claim 1, wherein said payment is by a loaning entity which lends money to said entity.

3. A method according to claim 1, wherein said entity is a country.

4. A method according to claim 1, wherein said entity does not pay for said provision more than 20% of a cost of said provision.

5. A method according to claim 1, comprising calculating a cost-effectiveness of a product.

6. A method according to claim 1, wherein providing comprises ranking products according to their health effects.

7. A method according to claim 1, wherein calculating comprises calculating according to a set of guidelines defined by a not-for-profit entity.

8. A method according to claim 1, comprising providing a certification to one or more products and collecting a certification fee from a manufacturer of such products.

9. A method according to claim 8, comprising negotiating with said entity to reduce market barriers to said certified products.

10. Apparatus for health care, comprising:
(a) at least one database storing product information related to health;
(b) a plurality of reading stations adapted to identify a product and provide product usage information in response thereto;
(c) a plurality of health monitoring stations adapted to acquire health information about individuals; and
(d) at least one analysis station adapted to correlate health information provided by said health monitoring stations with product usage information provided by said reading stations and determine therefrom an effect of said product on health.

11. Apparatus according to claim 10, wherein at least 10% of said health monitoring stations are located in persons' homes.

12. Apparatus according to claim 10, wherein at least 10% of said health monitoring stations are located in stores or healthcare locations.

13. Apparatus according to claim 10, wherein at least 10% of said reading stations are located in persons' homes.

14. Apparatus according to claim 10, wherein at least 30% of said reading stations are located in stores.

15. Apparatus according to claim 10, wherein at least 20% of said reading stations are adapted to record an identification of a person providing a product.

16. Apparatus according to claim 10, comprising a database of health information of said individuals.

17. Apparatus according to claim 10, wherein said analysis station is adapted to detect demographic specific effects for a demographic group smaller than 1% of said individuals.

18. Apparatus according to claim 10, wherein said analysis station is adapted to update said analysis at least once a week taking into account at least one factor that changes for an individual faster than once a week.

19. Apparatus according to claim 10, wherein said analysis station is adapted to take into account location specific effects relating to fewer than 1% of the individuals.

20. Apparatus according to claim 10, wherein said individuals comprise at least 50,000 individuals.

21. Apparatus according to claim 10, wherein at least one of said reading stations and said health monitoring stations are adapted to give individualized medical advice.

22. Apparatus according to claim 10, wherein at least one of said reading stations and said health monitoring stations are adapted to assist compliance by a user.

23. Apparatus according to claim 10, wherein said analysis station is adapted to determine the effect of a health promotion.

24. Apparatus according to claim 10, wherein said analysis station is adapted to determine a change in economic health burden of an entity comprising said individuals.

25. Apparatus according to claim 10, wherein said analysis station is adapted to suggest costing for products according to their determined health effects.

26. A method of health advice to a user characterized by demographic and personal criteria, comprising:
(a) receiving at least 10 queries a month from said user;
(b) extracting a suitable medical advice for said user in response to at least one of said queries, based on said user's demographic information and personal information; and
(c) reporting said advice to said user.

27. Apparatus for product costing, comprising:
(a) an input for basic product cost;
(b) an input for product economic health benefit; and
(c) circuitry for calculating a cost based on said basic price and based on said benefit.
